(19) United States
(12) Patent Application Publication
(10) Pub. No.: US 2020/0103845 A1
(43) Pub. Date: Apr. 2, 2020

(54) TOOL MONITORING SYSTEM AND TOOL MONITORING METHOD

(71) Applicant: INDUSTRIAL TECHNOLOGY RESEARCH INSTITUTE, Hsinchu (TW)

(72) Inventors: Yung-Sheng Chang, Hsinchu (TW); Yu-An Tseng, Hsinchu (TW); Yu-Ling Chang, Hsinchu (TW); Guo-Wei Wang, Hsinchu (TW); Chih-Yuan Hsu, Hsinchu (TW); Shuo-Peng Liang, Hsinchu (TW)

(21) Appl. No.: 16/211,560

(22) Filed: Dec. 6, 2018

(30) Foreign Application Priority Data
Oct. 1, 2018 (TW) 107134638

(51) Int. Cl. G05B 19/4065

(52) U.S. Cl. CPC G05B 19/4065; G05B 2219/50203; G05B 2219/50206

(57) ABSTRACT

A tool monitoring method and a tool monitoring system are provided. The tool monitoring method includes extracting a first data and a second data of a tool of a machine tool, simulating and analyzing the first data to generate a comparison value, calculating the second data to obtain an actual value, and integrating and comparing the comparison value with the actual value to produce a comparison result for monitoring the operating condition of the tool.

### CROSS REFERENCE TO RELATED APPLICATION

This application claims the priority benefit of Taiwan application serial no. 107134638, filed on Oct. 1, 2018. The entirety of the above-mentioned patent application is hereby incorporated by reference herein.

### BACKGROUND

### 1. Technical Field

The present disclosure generally relates to monitoring systems, and more particularly, to a tool monitoring system and a monitoring method for monitoring the operating condition of a tool in a machine tool in real time.

### 2. Description of Related Art

With the rapid advancement in machine tool automation, entry of relevant parameters has been a popular choice for carrying out related processing operations. Computer Numerical Control (CNC) has thus been widely applied in machine tools for processing.

Moreover, with the development in advance manufacturing technology, more stability and reliability of machining have been demanded. In actual machining processes, tool failures often contribute to the degrading of the efficiency, precision, quality, stability and reliability of the machining processes. As a result, selecting appropriate machining parameters during the machining processes is critical in improving the precision and quality of the processes.

In a traditional machining operation, a virtual machine is often designed first using a simulation system, and a database is then established using the virtual machine (e.g., machining parameters for different tools, parameters for different workpieces to be machined). Therefore, before the actual processing, a dry run can be carried out to obtain forecast data. In conjunction with the reference data in the database, compensations required by the machine tool can then be performed (e.g., the path of a tool is compensated), such that the tools can carry out efficient machining operations based on the compensation data.

However, in the production line, the same tool may wear out or have mechanical abnormality after processing the same type of products for a large number of times. Since the specifications of the tool and the target workpieces are unchanged, the same set of compensation data is used unaware of the wear out or abnormality, resulting in inefficient machining operations. Thus, it is often after an entire batch of products has been processed can one discover processing defects on products being processed later in the sequence.

These processing defects cannot be detected in real time, and the defects have to be discarded.

Furthermore, a great number of sensors can be installed on the machine tool to sense operations of the machine tool or the controller in real time. However, these sensors installed on the machine tool are not only expensive but also significantly increases the cost of monitoring. Their testing precision is also susceptible to environmental or electromagnetic interferences.

Moreover, there are numerous types of target workpieces and a wide array of applicable tools, so a large number of databases will need to be established for the same machine tool. The establishing of these databases is cumbersome.

Thus, there is a need in the art to provide a tool monitoring system that reduces the monitoring cost while reflecting in real time the processing conditions of the machine tool.

### SUMMARY

According to an embodiment of the present disclosure, a tool monitoring system is disclosed, which is connectible to a machine tool equipped with a controller and a tool. The tool monitoring system may include: an extracting portion for extracting a first data and a second data from the controller; an analysis portion for simulating and analyzing the first data to generate a comparison value; a calculating portion for calculating the second data to obtain an actual value; and an integration portion for integrating and comparing the comparison value with the actual value to produce a comparison result for monitoring the operating condition of the tool.

According to another embodiment of the present disclosure, a tool monitoring method is disclosed which is applicable to a machine tool equipped with a controller and a tool. The tool monitoring method comprises: extracting a first data and a second data from the controller; simulating and analyzing the first data to generate a comparison value, and calculating the second data to obtain an actual value; and integrating and comparing the comparison value with the actual value to produce a comparison result for monitoring the operating condition of the tool.

### BRIEF DESCRIPTION OF THE DRAWINGS

FIG. 1A is a schematic diagram depicting the arrangement of a tool monitoring system in accordance with the present disclosure.

FIG. 1B is a schematic diagram depicting the arrangement of a tool monitored by the tool monitoring system in accordance with the present disclosure.

FIG. 2A is a schematic diagram depicting operations of the tool monitoring system in accordance with the present disclosure.

FIG. 2B is a flowchart illustrating a tool monitoring method in accordance with the present disclosure.

FIGS. 3A to 3C are tables of relevant data during the acquisition of comparison values in the tool monitoring system in accordance with the present disclosure.

FIGS. 4A to 4D are tables of relevant data during the acquisition of actual values in the tool monitoring system in accordance with the present disclosure.

FIG. 5A is a table of comparison results produced by the tool monitoring system in accordance with the present disclosure.

FIG. 5B is a graph depicting comparison results produced by the tool monitoring system in accordance with the present disclosure.

FIG. 6 is another implementation of the tool monitoring system in accordance with the present disclosure.

### DETAILED DESCRIPTION OF EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

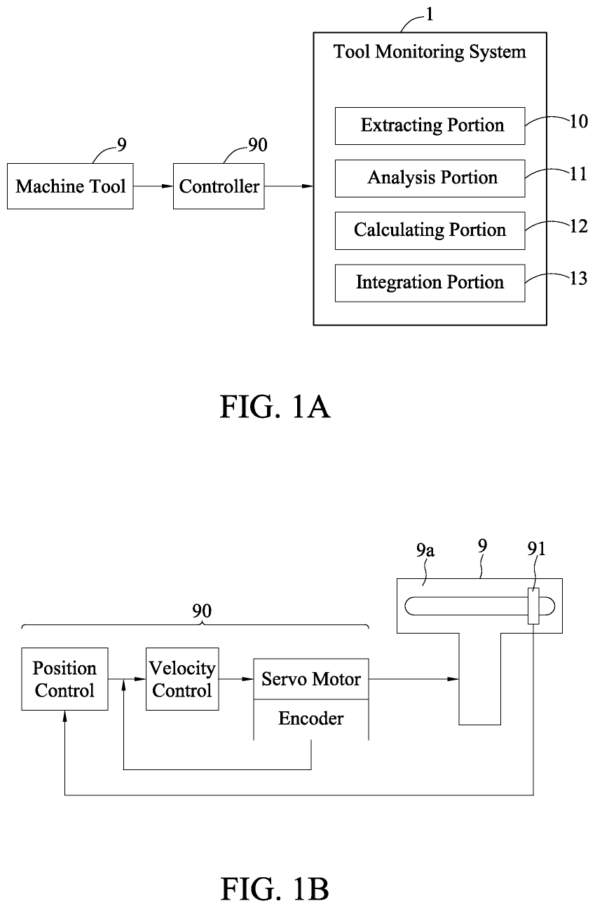

FIG. 1A is a schematic diagram depicting the arrangement of a tool monitoring system 1 in accordance with the present disclosure. The tool monitoring system 1 includes, for example, an extracting portion 10, an analysis portion 11, a calculating portion 12, and an integration portion 13. However, the present disclosure does not limit the possible integrations, replacements, additions, deletions of these portions arranged above.

Referring to FIG. 1B, in an embodiment, the tool monitoring system 1 is applicable to a CNC machine tool 9. The machine tool 9 is equipped with a controller 90 and a tool 91 (e.g., a cutting tool shown in FIG. 1B) installed on a work platform 9a. The tool monitoring system 1 may be, for example, included in the machine tool 9 or a stand-alone computer (e.g., a remote computer, a personal computer, a tablet, a mobile phone, etc.) and is capable of performing calculations and displaying monitoring results.

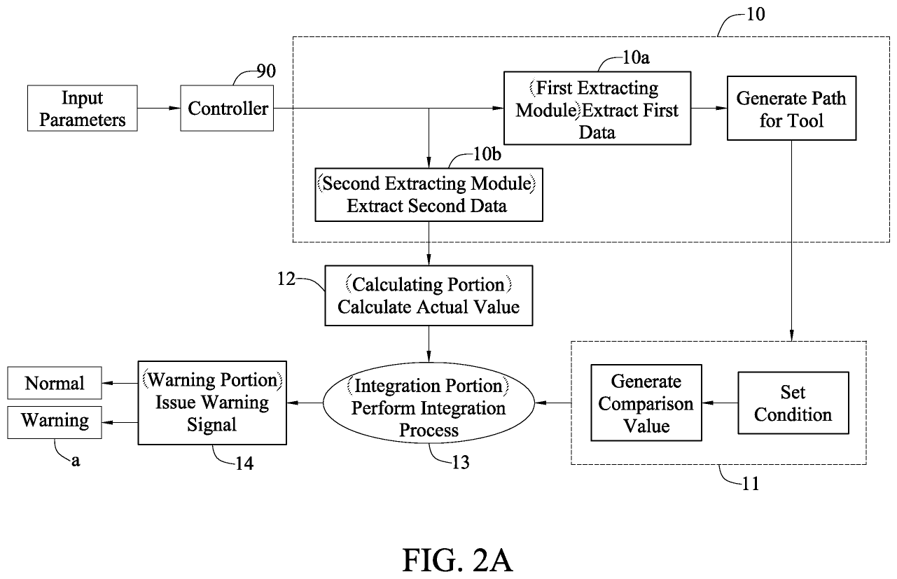

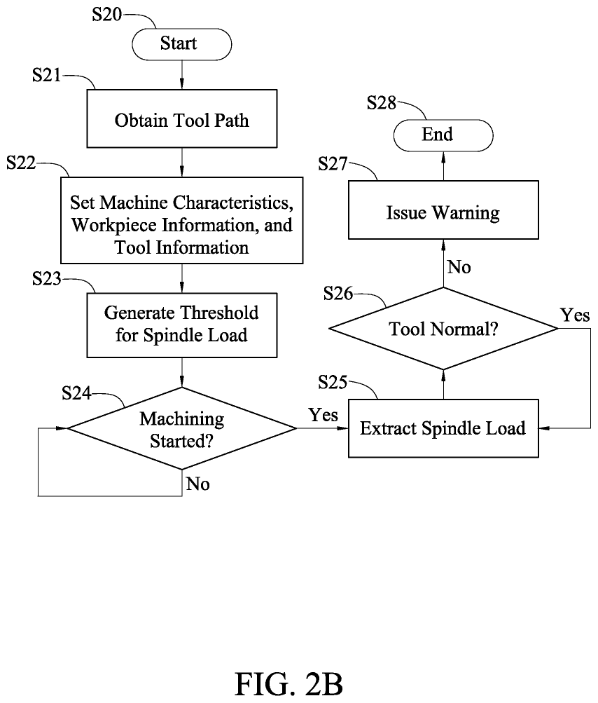

The extracting portion 10 is used for extracting a first data and a second data from the controller 90. In an embodiment, the extracting portion 10 shown in FIG. 2A includes a first extracting module 10a for extracting the first data and a second extracting module 10b for extracting the second data.

In an embodiment, the first data includes the coordinates, the feed rate, and the spindle rotational speed of the tool 91, while the second data is the spindle load of the tool 91. The extracting portion 10 converts the coordinates and the feed rate of the tool 91 into a path (or processing path) of the tool 91. In another embodiment, in the first data, the coordinate information may be, for example, the coordinate data of the path of the tool 91 during the dry run of the machine tool 9 as mentioned above. They have corresponding program code types or program code line number. In an embodiment, the coordinate information may include coordinates, G code type, NC code line number or other relevant instructions.

The analysis portion 11 is used for simulating and analyzing the first data to obtain a comparison value. In an embodiment, the analysis portion 11 shown in FIG. 2A simulates a reference value for the spindle load of the tool 91 using the path of the tool 91 obtained by the extracting portion 10. The reference value is used as the comparison value.

In an embodiment, the analysis portion 11 is a virtual machine that models the machine tool 9 or the controller 90, and simulates the motions of the machine tool 9 before and after adjustments of parameters. In an embodiment, the virtual machine provides a plurality of interfaces for displaying parameters and allowing a user to set relevant simulation conditions, such as the machine characteristics of the machine tool 9, information about a target workpiece, information about the tool 91, etc. The virtual machine may optionally resemble the appearance of the machine. Therefore, there are numerous aspects of virtual machines and the present disclosure is not limited to the above.

The calculating portion 12 is used for calculating an actual value based on the second data. In an embodiment, the calculating portion 12 shown in FIG. 2A calculates the difference in the average spindle load for each tooth period of the tool 91 as the actual value.

The integration portion 13 compares the comparison value with the actual value and uses the comparison result to monitor the operations of the machine tool 9.

In an embodiment, as shown in FIG. 2A, the tool monitoring system 1 further includes a warning portion 14 for issuing a warning signal a based on the comparison result of the integration portion 13 in order to trigger a warning mechanism, such as light, an alarm bell, a computer image or other mechanisms (e.g., forced shut down of the machine), etc.

In the schematic diagram of FIG. 2A depicting the operations of the tool monitoring system 1, the user first inputs parameters into the controller 90, such that the extracting portion 10 extracts the first data (the coordinates, the feed rate and the spindle rotational speed of the tool 91) and the second data (e.g., the spindle load of the tool 91) from the controller 90 of the machine tool 9 through communication (e.g., a network). The first data is converted into the path of the tool 91.

In an embodiment, the way that the data are extracted by the extracting portion 10 may include internal direction transfer (e.g., in the case of the machine tool 9 equipped with the tool monitoring system 1), via an application interface (e.g., for obtaining internal information of a digital controller of the machine tool 9), via a programmable logic controller (PLC) for transferring and temporarily storing internal and external signals of a digital controller 90, direct transfer of external devices (e.g., coordinate signals transmitted by an encoder, coordinate signals transmitted by an optical ruler, coordinates, NC code line numbers, or G code types transmitted by a data extraction card). In an embodiment, the parameter can be a G code type.

During the operations of the machine tool 9, the tool monitoring system 1 may obtain and record coordinate data of the path of the tool 91 of the machine tool 9 from various sources, including, example, a position controller of the controller 90 of the machine tool 9, an encoder on a servo motor of the machine tool 9, and an optical ruler on the work platform.

After relevant simulation conditions (e.g., the machine characteristics of the machine tool 9, information about the target workpiece, information about the tool 91, etc.) are set in the analysis portion 11, simulation is performed in view of the path of the tool 91 to generate the required comparison value (e.g., a reference value of the spindle load of the tool 91, i.e., a threshold for the load of the tool). The calculating portion 12 calculates the actual value (e.g., the difference in average spindle load for each tooth period of the tool 91) using the second data.

Thereafter, the integration portion 13 integrates the comparison value (e.g., the threshold for the spindle load) with the actual value (e.g., the difference in the spindle load) by integrating and comparing the virtual data and the actual data to obtain a comparison result for monitoring the operations of the machine tool 9 (or the real time condition of the tool 91). The warning portion 14 obtains the comparison resulting (e.g., analysis of the condition of the tool) as the basis for issuing the warning signal a.

Therefore, the tool monitoring method in accordance with the present disclosure obtains the first and second data of the same path of the tool 91 by the extracting portion 10; simulates the comparison value using the analysis portion 11; calculates the actual value using the calculating portion 12; and integrates the comparison value and the actual value using the integration portion 13, thereby monitoring the operations of the machine tool 9 or the real-time condition of the tool 91.

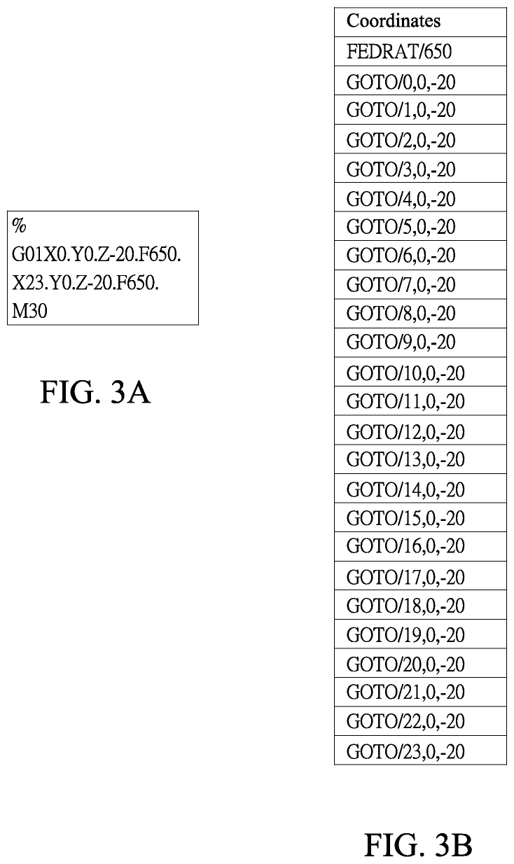

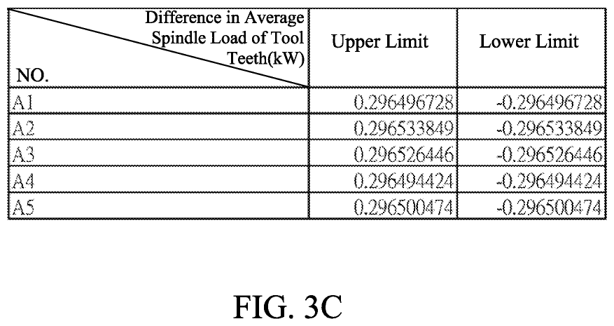

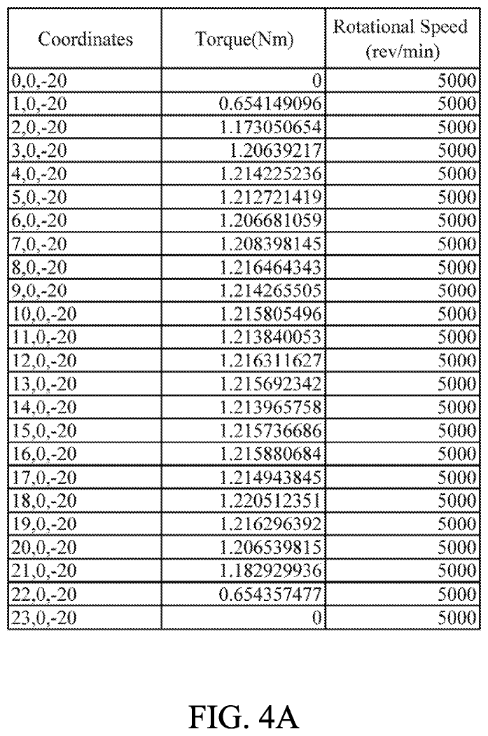

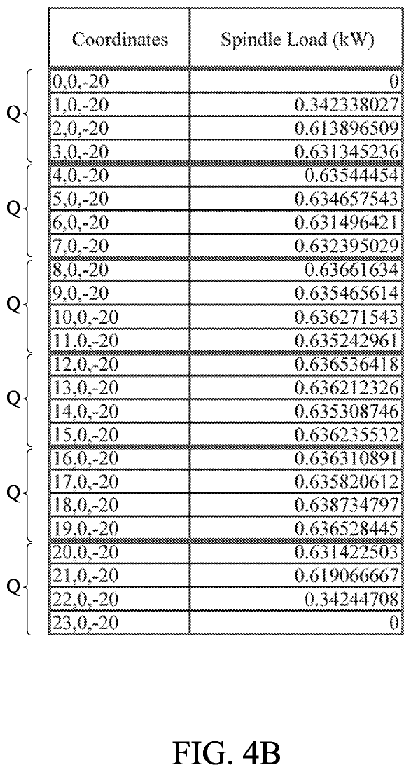

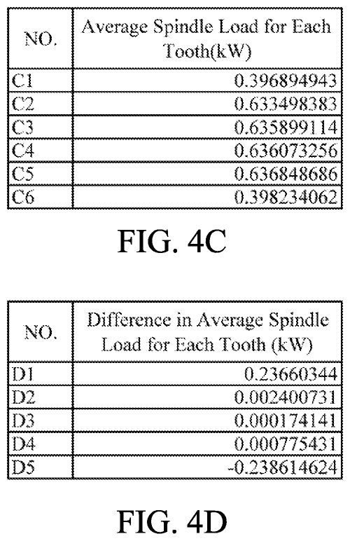

FIG. 2B is a flowchart illustrating a tool monitoring method in accordance with the present disclosure. FIGS. 3A to 3C are tables of relevant data during the acquisition of the comparison value in the tool monitoring method. FIGS. 4A to 4D are tables of relevant data during the acquisition of the actual value in the tool monitoring method.

In step S20, the machine tool 9 and the tool monitoring system 1 are activated and parameters are inputted (e.g., a G-code program shown in FIG. 3A). In step S21, a dry run of the tool 91 of the machine tool 9 is performed before actual processing, and the first data (the coordinates, the feed rate, and the spindle rotational speed of the tool 91) of the machine tool 9 is extracted by the extracting portion 10 and converted into a path of the tool 91 (coordinate data of the path is for example shown in FIG. 3B).

In step S22, the analysis portion 11 (e.g., the virtual machine) sets the machine characteristics of the machine tool 9, information about a target workpiece, information about the tool 91, and other relevant simulation conditions. In step S23, a built-in program of the analysis portion 11 generates a comparison value based on the simulation conditions in conjunction with the path of the tool 91. In an embodiment, the comparison value includes the upper and lower limits of the difference in the average spindle load for each tooth period of the tool 91, including, for example, five sets of threshold values of the spindle load (numbered A1-A5) shown in FIG. 3C. There are numerous algorithms for simulating and analyzing that can be performed by the built-in program of the analysis portion 11, and the present disclosure is not limited to any particular algorithm.

In step S24, machining of a target workpiece is performed. The workpiece is placed on the work platform 9a, and the controller 90 instructs the tool 91 to perform machining on the target workpiece. When the machining is carried out by the tool 91, as shown in step 25, the extracting portion 10 extracts corresponding coordinates, torques, rotational speeds, etc. related to the path of the tool 91 (shown in FIG. 4A), and the data are converted into the spindle loads of the tool 91 (as shown by the second data in FIG. 4B).

In an embodiment, torque and rotational speed can be converted into spindle load using a formula (a) below:

Spindle Load=Torque·(Rotational speed·2π/60)/1000 (a)

In step S26, the calculating portion 12 calculates the difference in the average spindle load for each tooth period of the tool 91 based on the spindle load (as shown in FIG. 4D), and uses the difference in the average spindle load e as the actual value. Based on the data shown in FIG. 4B (every four sets of data outlined in bold lines is regarded as one calculation unit Q), the average spindle loads for each tooth period are calculated as follows (six sets of data numbered C1-C6 shown in FIG. 4C):

$$P ( m ) = {\sum }_{i = 1}^{k} \frac{{P}_{S} ( i )}{k} \qquad ( b )$$

wherein P(m) is the average spindle load for each tooth period; k is 60.1000/rotational speed/number of teeth, and PS(i) is the spindle load for each coordinate (kW). Based on the data shown in FIG. 4C, a difference is obtained by subtracting each calculated spindle load value from the spindle load value immediately after it (i.e., P(m)-P(m−1)). As a result, five difference values are obtained, as shown in FIG. 4D (numbered D1-D5).

The integration portion 13 then compares the comparison values (data numbered A1-A5 in FIG. 3C) with the actual values (data numbered D1-D5 in FIG. 4D) to determine if the tool 91 is functioning normally. Thus, the real-time condition of the machine tool 9 can be monitored. During the comparison process performed by the integration portion 13, data corresponding to the same coordinates are compared. In other words, A1 corresponds to D1; A2 corresponds to D2; and so on. As such, it can be determined whether an actual value exceeds the range bounded by the upper and lower limits in the corresponding comparison value.

If the actual value does not exceed the boundary of the corresponding comparison value, which indicates that the tool 91 is in a normal state, the machine tool 9 may continue its operations (e.g., the processing of the next target workpiece of the same type), and the tool monitoring system 1 will continue to extract the data from the controller 90 (e.g., only the second data of the next workpiece to be processed is extracted, but not the first data as it is the same as the previous workpiece (same type)).

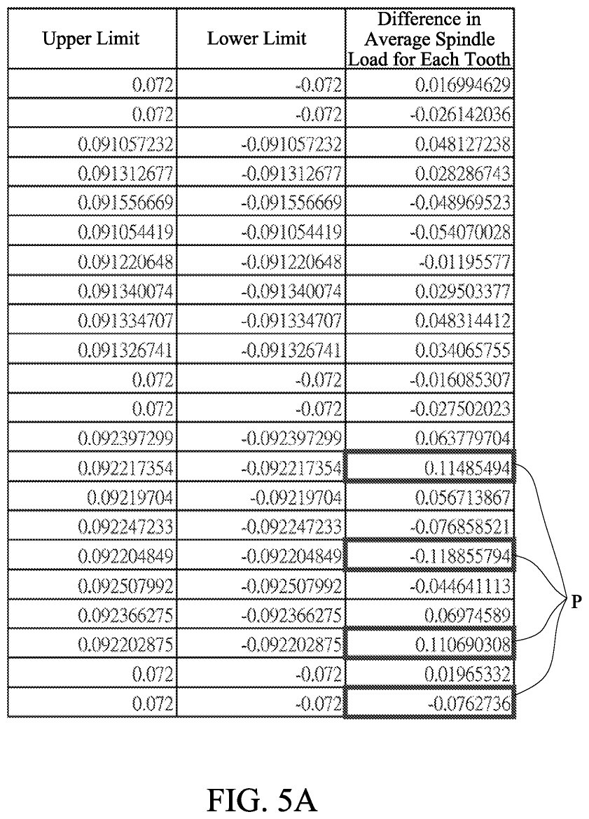

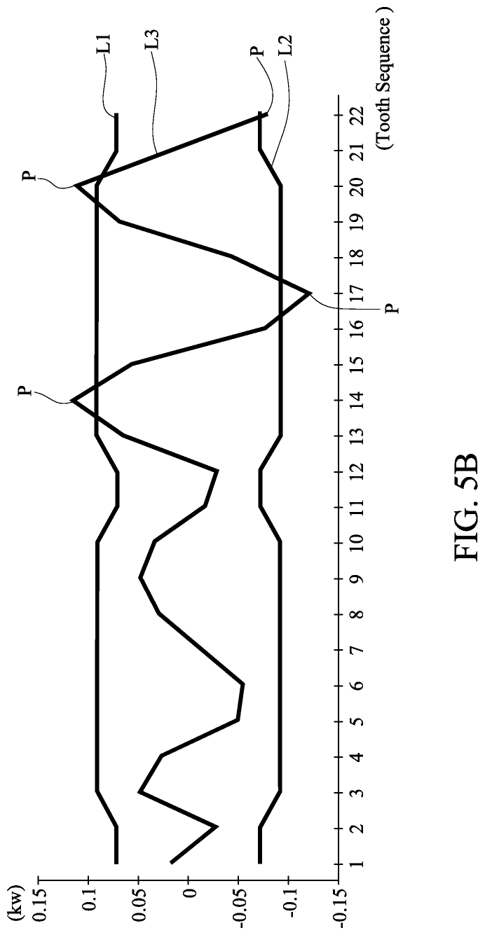

On the contrary, if the actual value exceeds the boundary of the corresponding comparison value (e.g., shown as anomalies P in FIG. 5A), it is indicated that the tool 91 is not in a normal state (shown by anomalies P in the real time curve L3 exceeding the upper limits L1 and the lower limits L2 in FIG. 5B, which may be displayed on a computer screen). Accordingly, the warning portion 14 of the tool monitoring system 1 will issue a warning signal a, as shown in step S27, to notify (e.g., by light, an alarm bell, a screen image or other ways) the user or forcibly stop the operations of the machine tool 9, thereby ending the monitoring process as shown by step S28. The user can then replace the tool 91 instead of having to wait until the processing of an entire batch of workpiece is finished.

In summary, the tool monitoring system 1 and the tool monitor method in accordance with the present disclosure obtain the first data (e.g., data from a dry run) and the second data (e.g., data during processing) of workpieces of the same type and of the same path using the extracting portion 10, and obtains values of the same number of units using the analysis portion 11 (e.g., a virtual machine) and the calculating portion 12 based on the first data and the second data, respectively. These values are then compared to monitor the processing condition of the target workpieces in real time. Therefore, on the production line, during the machining of a plurality of workpiece by the same tool 91, if wear out or mechanical abnormality occurs in the tool 91, it can be discovered in real time, and the process is immediately paused. Compared to the prior art, the tool monitoring system 1 and the tool monitor method in accordance with the present disclosure allow the user to be able to replace or fix the tool 91 during the processing of a whole batch of products. This avoids the increase of defects and effectively minimizes loss of target workpieces or products.

Moreover, the present disclosure requires no large number of sensors to be installed on the machine tool 9, thereby significantly reducing the cost of monitoring. Also, the monitoring precision will not be affected by environmental factors or electromagnetic interferences.

Furthermore, the present disclosure only requires the extraction of the first and second data on site for real time monitoring, database technology is not needed. Thus, compared to the prior art, the present disclosure requires no establishing of database before processing, thus saving processing time while simplifying processing.

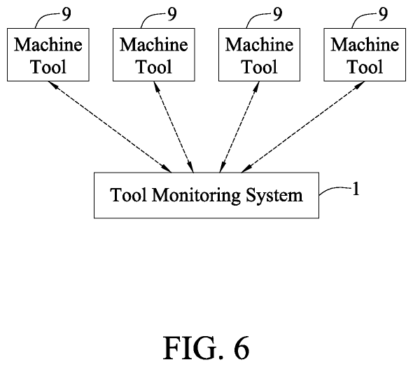

In addition, machine tools 9 of the same kind may use the same tool monitoring system 1 (since the virtual machine of the analysis portion 11 is the same). Therefore, the tool monitoring system 1 is capable of monitoring the operations of a plurality of machine tools 9 of the same kind, as shown in FIG. 6.

While particular embodiments of the disclosure have been disclosed in detail herein, it should be appreciated that the disclosure is not limited thereto or thereby inasmuch as variations on the disclosure herein will be readily appreciated by those of ordinary skill in the art. The scope of the disclosure shall be appreciated from the claims that follow.

What is claimed is:

1. A tool monitoring system connectible to a machine tool equipped with a controller and a tool, the tool monitoring system comprising:
an extracting portion configured for extracting a first data and a second data from the controller;
an analysis portion configured for simulating and analyzing the first data to generate a comparison value;
a calculating portion configured for calculating the second data to obtain an actual value; and
an integration portion configured for integrating and comparing the comparison value with the actual value to produce a comparison result for monitoring an operating condition of the tool.

2. The tool monitoring system of claim 1, wherein the first data includes coordinates, a feed rate, and a spindle rotational speed of the tool.

3. The tool monitoring system of claim 1, wherein the second data includes a spindle load of the tool.

4. The tool monitoring system of claim 1, wherein the analysis portion is a virtual machine of the machine tool or the controller.

5. The tool monitoring system of claim 1, wherein the extracting portion converts the first data into a path of the tool, and the analysis portion uses the path in simulating and analyzing a reference value of a spindle load of the tool to be used as the comparison value.

6. The tool monitoring system of claim 1, wherein the calculating portion calculates a spindle load value of the tool using the second data and uses the spindle load value as the actual value.

7. The tool monitoring system of claim 6, wherein the spindle load value of the tool is a difference in an average spindle load for each tooth period to be used as the actual value.

8. The tool monitoring system of claim 1, wherein the comparison result generated by the integration portion is a result of an analysis of the operating condition of the tool.

9. The tool monitoring system of claim 1, further comprising a warning portion configured for outputting a warning signal based on the comparison result from the integration portion.

10. A tool monitoring method applicable to a machine tool equipped with a controller and a tool, the method comprising:
extracting a first data and a second data from the controller;
simulating and analyzing the first data to generate a comparison value, and calculating the second data to obtain an actual value; and
integrating and comparing the comparison value with the actual value to produce a comparison result for monitoring an operating condition of the tool.

11. The tool monitoring method of claim 10, wherein the first data includes coordinates, a feed rate, and a spindle rotational speed of the tool.

12. The tool monitoring method of claim 10, wherein the second data includes a spindle load of the tool.

13. The tool monitoring method of claim 10, further comprising simulating and analyzing the first data to generate the comparison value by a virtual machine of the machine tool or the controller.

14. The tool monitoring method of claim 10, further comprising converting the first data into a path of the tool to simulate and analyze a reference value of a spindle load of the tool to be used as the comparison value.

15. The tool monitoring method of claim 10, further comprising calculating a spindle load value of the tool using the second data and using the spindle load value as the actual value.

16. The tool monitoring method of claim 15, wherein the spindle load value of the tool is a difference in an average spindle load for each tooth period to be is used as the actual value.

17. The tool monitoring method of claim 10, wherein the comparison result generated by the integration portion is a result of an analysis of the operating condition of the tool.

18. The tool monitoring method of claim 10, further comprising outputting a warning signal based on the comparison result.
